(19) United States
(12) Patent Application Publication
(10) Pub. No.: US 2024/0159464 A1
(43) Pub. Date: May 16, 2024

(54) AIR DRYER AND COMPRESSED GAS DRYING METHOD

(71) Applicant: Samsung Electronics Co., Ltd., Suwon-si (KR)

(72) Inventors: Sungmin Jang, Suwon-si (KR); Chiwon Kim, Suwon-si (KR)

(21) Appl. No.: 18/505,924

(22) Filed: Nov. 9, 2023

(30) Foreign Application Priority Data
Nov. 11, 2022 (KR) 10-2022-0150987

(51) Int. Cl. F26B 21/10; F26B 23/04

(52) U.S. Cl. CPC F26B 21/10; F26B 23/04

(57) ABSTRACT

Provided is an air dryer including a first tank, a first line through which gas is supplied to an inside of the first tank, a heater configured to heat the gas, and a first heater line through which the gas is supplied to the heater, wherein the heater includes a housing having a shape extending in a first direction, and having a space formed therein, a plurality of baffles arranged in the housing to be substantially parallel to a first plane, and separated from each other in the first direction, and a hot wire passing through each of the plurality of, wherein the plurality of baffles include a first baffle having a plurality of first holes and a second baffle having a plurality of first holes formed in a second region other than the first region to extend in the first direction.

### CROSS-REFERENCE TO RELATED APPLICATION

This application is based on and claims priority under 35 U.S.C. § 119 to Korean Patent Application No. 10-2022-0150987, filed on Nov. 11, 2022, in the Korean Intellectual Property Office, the disclosure of which is incorporated by reference herein in its entirety.

### BACKGROUND

The inventive concept relates to an air dryer and a compressed gas drying method, and more particularly, to an air dryer capable of improving the efficiency of a heater, and a compressed gas drying method.

A semiconductor device may be fabricated by various processes. For example, a semiconductor device may be fabricated by undergoing an etching process, a deposition process, a development process, a test process, and the like. In some semiconductor device fabrication processes, it may be necessary to introduce gas. For example, gas may be introduced to the inside of a chamber in which a semiconductor device is fabricated. In this case, the humidity of gas supplied to semiconductor device fabrication processes may be controlled to be low. A process of drying supplied gas into dried gas may be added in the fabrication process. To dry gas into dried gas, a process of passing the gas through a tank filled with an adsorbent may be helpful.

### SUMMARY

An aspect of the inventive concept provides an air dryer with an efficiency-improved heater, and a compressed gas drying method.

Issues addressed by technical ideas of the inventive concept are not limited to the issues mentioned above, and the other issues could be clearly understood by those of ordinary skill in the art from the description below.

According to an aspect of the inventive concept, there is provided an air dryer. The air dryer includes a first tank having a space formed therein, a first line configured such that a gas is supplied to an inside of the first tank through the first line, a heater configured to heat the gas, and a first heater line configured such that the gas is supplied to the heater through the first heater line, wherein the heater includes a housing having a shape extending in a first direction and having a space formed therein, a plurality of baffles arranged in the housing to be substantially parallel to a first plane of which a normal vector is parallel to the first direction, the plurality of baffles separated from each other in the first direction, and a hot wire passing through each of the plurality of baffles in the first direction, wherein the plurality of baffles include a first baffle having a plurality of first holes formed in a first region to extend in the first direction and a second baffle having a plurality of first holes formed in a second region other than the first region to extend in the first direction.

According to another aspect of the inventive concept, there is provided an air dryer including a first tank having a space formed therein, a first line configured such that a gas is supplied to an inside of the first tank through the first line, a heater configured to heat the gas, a first heater line configured such that the gas is supplied to the heater through the first heater line, a second tank having a space formed therein, a fourth line configured such that the gas having passed through the heater is supplied to the second tank through the fourth line, a discharge line configured such that the gas having passed through the second tank is discharged to the outside through the discharge line, and a first dew point measuring instrument configured to measure a dew point of the gas having passed through the discharge line.

According to another aspect of the inventive concept, there is provided a compressed gas drying method.

The compressed gas drying method includes providing compressed gas compressed by a compressor to an air dryer, drying the compressed gas in a first tank in which an adsorbent is provided, in a second tank in which the adsorbent is provided, regenerating the adsorbent, drying the compressed gas in the second tank after finishing the regeneration of the adsorbent in the second tank, and regenerating, in the first tank, the adsorbent provided in the first tank,
wherein the regenerating of the adsorbent provided in the second tank includes drying the adsorbent provided in the second tank and cooling the dried adsorbent, wherein the drying of the adsorbent includes providing gas to a heater, providing, to the second tank, the gas having passed through the heater, measuring a dew point temperature of the gas having passed through the second tank, and stopping the heater when the dew point temperature is measured as being less than or equal to a first temperature.

### BRIEF DESCRIPTION OF THE DRAWINGS

Embodiments of the inventive concept will be more clearly understood from the following detailed description taken in conjunction with the accompanying drawings in which:

FIGS. 1A and 1B are schematic structural diagrams illustrating air dryers according to technical ideas of the inventive concept;

FIG. 2 is a schematic conceptual diagram illustrating a tank of an air dryer, according to a technical idea of the inventive concept;

FIG. 3 is a flowchart illustrating a gas drying method of the air dryers of FIGS. 1A and 1B;

FIG. 4 is a flowchart illustrating an adsorbent regeneration method of an air dryer, according to a technical idea of the inventive concept;

FIG. 5 is a schematic conceptual diagram illustrating a heater of an air dryer, according to a technical idea of the inventive concept;

FIG. 6 is a schematic conceptual diagram illustrating a flow of gas passing through the inside of the heater of FIG. 5;

FIGS. 7 and 8 are schematic cross-sectional views illustrating a first baffle and a second baffle in the heater of FIG. 5; and

FIGS. 9A and 9B are schematic structural diagrams illustrating air dryers according to a technical idea of the inventive concept.

### DETAILED DESCRIPTION OF THE EMBODIMENTS

Hereinafter, embodiments are described in detail with reference to the accompanying drawings. Like reference numerals in the drawings denote like elements, and thus their repetitive description is omitted.

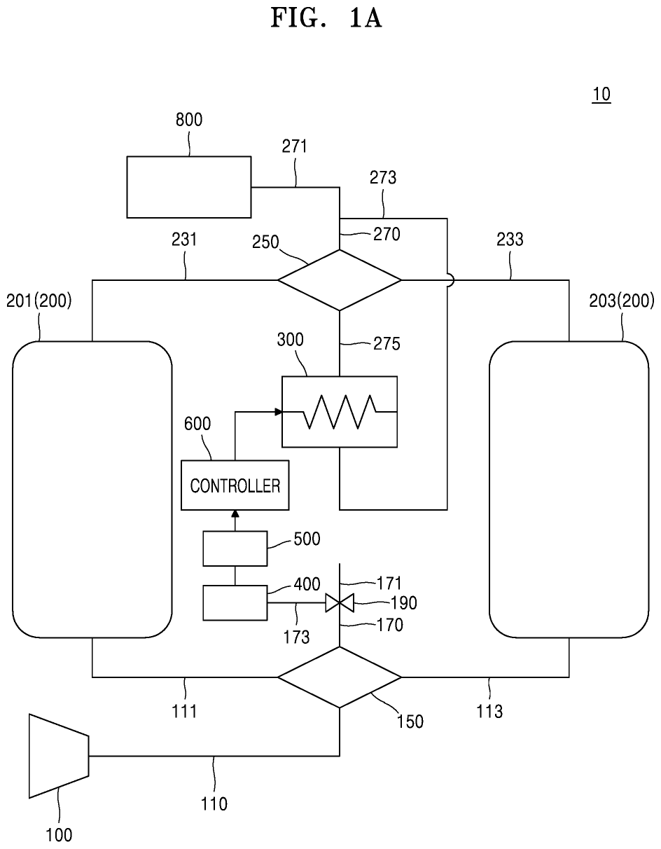

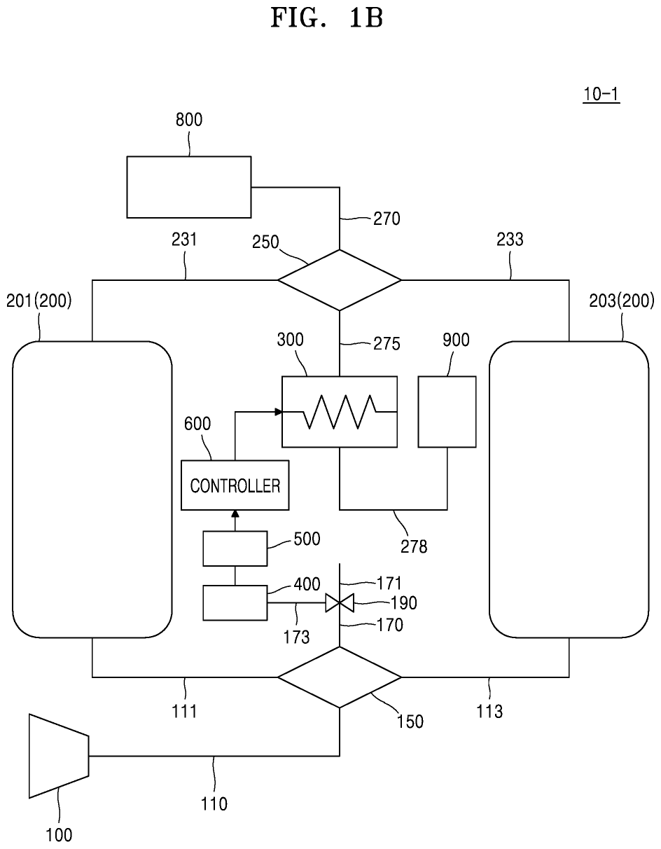

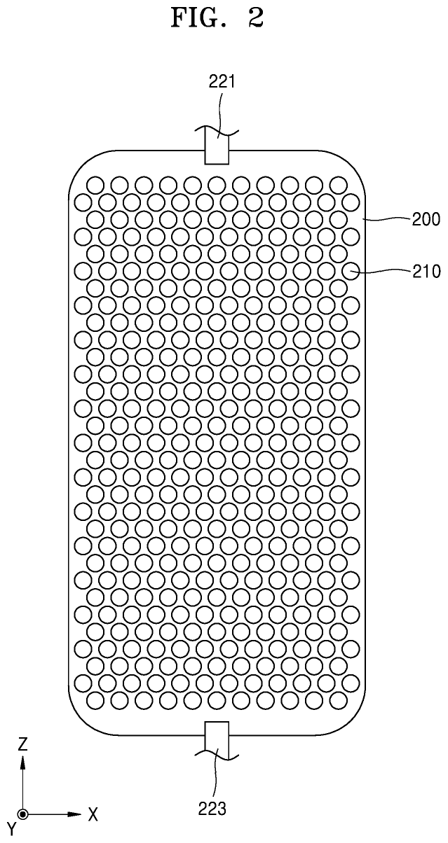

FIGS. 1A and 1B are schematic structural diagrams illustrating air dryers 10 and 10-1 according to technical ideas of the inventive concept. FIG. 2 is a schematic conceptual diagram illustrating a tank 200 of an air dryer, according to a technical idea of the inventive concept.

Referring to FIGS. 1A and 2, the air dryer 10 may be configured to remove moisture of compressed gas supplied from a compressor 100. Herein, the compressed gas compressed by the compressor 100 may be provided to the air dryer 10 through a gas supply line 110. According to embodiments, the compressed gas may be compressed air but is not limited thereto, and the compressed gas may be any gas from which removal of moisture is necessary or beneficial.

According to embodiments, the air dryer 10 may be an adsorption-type air dryer, e.g., using a compressed air container/tank filled with desiccant, but is not limited thereto, and the air dryer 10 may include or may be an absorption-type (e.g., using a deliquescent desiccant) or cooling-type (e.g., cooling compressed air using a heat exchanger) air dryer. According to embodiments, the air dryer 10 may be a heater purge type air dryer but is not limited thereto, and the air dryer 10 may be a blower non-purge type air dryer as shown in FIG. 1B, or the air dryer 10 may be any dual-type air dryer including a heater 300.

According to embodiments, the air dryer 10 may include the tank 200, a first line 111, a third line 113, a second line 231, a fourth line 233, a fifth line 270, a fabline 271, the heater 300, a first heater line 273, a second heater line 275, a first valve 150, a second valve 250, a discharge line 170, a first branched discharge line 171, a second branched discharge line 173, a cooler 400, a dew point measuring instrument 500, and a controller 600.

The gas supply line 110 may supply therethrough compressed gas to the tank 200. According to embodiments, a plurality of tanks 200 may be provided. For example, the air dryer 10 may include a first tank 201 and a second tank 203. The tank 200 may be configured to remove moisture of compressed gas supplied to the tank 200. For example, the tank 200 may be configured to remove moisture of compressed gas passing through the tank 200. According to embodiments, the tank 200 may have a cylindrical shape having a space formed therein, and extending in one direction. An adsorbent 210 may be provided in the tank 200. As shown in FIG. 2, the adsorbent 210 may be stacked inside the tank 200 to fill the tank 200.

In the drawings below, a Z-axis direction may indicate a direction in which the adsorbent 210 is stacked, an X-axis direction and a Y-axis direction may indicate directions parallel to a plane that is perpendicular to the Z-axis direction, and the X-axis direction may be perpendicular to the Y-axis direction.

In the drawings below, it could be understood that a first horizontal direction is the X-axis direction, a second horizontal direction is the Y-axis direction, and a vertical direction is the Z-axis direction.

The adsorbent 210 may be provided in the tank 200 to remove moisture of compressed gas passing through the tank 200. According to embodiments, the adsorbent 210 may include or be formed of silica gel, activated alumina, or molecular sieves but is not limited thereto, and the adsorbent 210 may be any material capable of removing moisture included in compressed gas. For example, the adsorbent 201 may be formed of or may be a desiccant.

According to embodiments, the first line 111 may be connected to (e.g., extend from) the first tank 201, and the third line 113 may be connected to (e.g., extend from) the second tank 203. According to embodiments, compressed gas provided to the first line 111 through the gas supply line 110 may be supplied to the first tank 201 through the first line 111, and compressed gas provided to the third line 113 through the gas supply line 110 may be supplied to the second tank 203 through the third line 113.

According to embodiments, compressed gas having passed through the gas supply line 110 may be alternately supplied to the first tank 201 and the second tank 203. For example, when compressed gas having passed through the gas supply line 110 is supplied to the first tank 201 through the first line 111, the compressed gas having passed through the gas supply line 110 may not be introduced to the third line 113, and on the contrary, when compressed gas having passed through the gas supply line 110 is supplied to the second tank 203 through the third line 113, the compressed gas having passed through the gas supply line 110 may not be introduced to the first line 111.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The first valve 150 may be connected to the gas supply line 110, the first line 111, the third line 113, and the discharge line 170. The first valve 150 may set a path of compressed gas, which passes through the gas supply line 110, the first line 111, the third line 113, and the discharge line 170 connected to (e.g., extending from) the first valve 150. For example, compressed gas having passed through the gas supply line 110 may be provided to the first line 111 by/via the first valve 150, and in this case, the compressed gas may not be provided to the third line 113 and the discharge line 170. Alternatively, compressed gas having passed through the gas supply line 110 may be provided to the third line 113 by/via the first valve 150, and in this case, the compressed gas may not be provided to the first line 111 and the discharge line 170.

As a result, because compressed gas supplied through the gas supply line 110 is alternately provided to the first line 111 and the third line 113, the compressed gas may also be alternately provided to the first tank 201 and the second tank 203.

The tank 200 may include a first opening 223 and a second opening 221. The first opening 223 and the second opening 221 may be holes through which compressed gas flows in or out of the tank 200. In some embodiments, the first opening 223 may be formed in one surface (or a wall) of the tank 200, and the second opening 221 may be formed in a surface opposite to the one surface. According to embodiments, the first opening 223 of the first tank 201 may be connected to the first line 111, and the first opening 223 of the second tank 203 may be connected to the third line 113.

The second opening 221 of the first tank 201 may be connected to the second line 231, and the second opening 221 of the second tank 203 may be connected to the fourth line 233.

According to embodiments, the tank 200 may further include a discharge filter (not shown). The discharge filter may be configured to prevent the adsorbent 210 from escaping through the first opening 223 and/or the second opening 221. The discharge filter may be provided by being coupled to the first opening 223 and the second opening 221.

The second line 231 may connect the first tank 201 and the second valve 250 to each other. According to embodiments, compressed gas supplied to the first tank 201 through the first line 111 may be provided to the second line 231 in a state in which moisture is removed from the compressed gas. The compressed gas provided to the second line 231 may be supplied to the fifth line 270 through the second valve 250.

The fourth line 233 may connect the second tank 203 and the second valve 250 to each other. For example, the fourth line 233 may be connected to the second tank 203 at one end, and to the second valve 250 at the other end. According to embodiments, compressed gas supplied to the second tank 203 through the third line 113 may be provided to the fourth line 233 in a state in which moisture is removed from the compressed gas. The compressed gas provided to the fourth line 233 may be supplied to the fifth line 270 through the second valve 250.

A part of compressed gas supplied to the fifth line 270 may be provided to a fab 800 through the fabline 271. According to embodiments, the fab 800 may include or may be equipment configured to perform a semiconductor fabrication process, and the fabline 271 may be a supply line supplying dried compressed gas to the fab 800. The other part of the compressed gas supplied to the fifth line 270 may be provided to the heater 300 through the first heater line 273. In some embodiments, about 85% to about 97% of compressed gas having passed through the fifth line 270 may be provided to the fab 800 through the fabline 271, and the residual compressed gas may be provided to the heater 300 through the first heater line 273. However, the percentages of compressed gas branched/supplied to the fabline 271 and the first heater line 273 are not limited thereto.

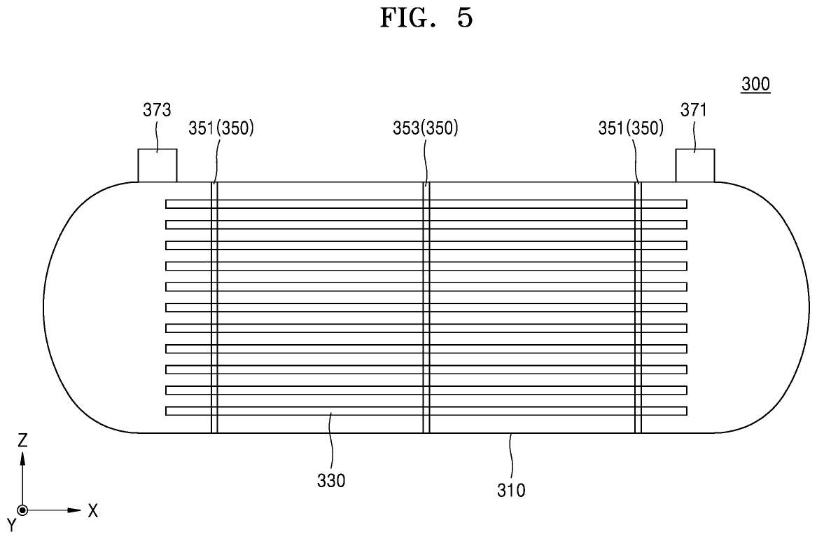

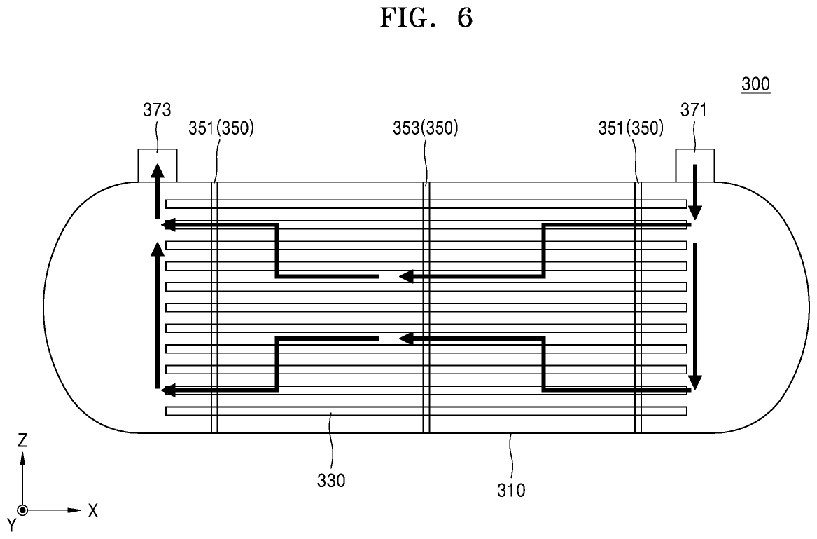

The heater 300 may be configured to heat compressed gas supplied to the heater 300 through the first heater line 273. A structure of the heater 300 is described in detail with reference to FIGS. 5 and 6.

Terms such as “about” or “approximately” may reflect amounts, sizes, orientations, or layouts that vary only in a small relative manner, and/or in a way that does not significantly alter the operation, functionality, or structure of certain elements. For example, a range from “about 0.1 to about 1” may encompass a range such as a 0%-5% deviation around 0.1 and a 0% to 5% deviation around 1, especially if such deviation maintains the same effect as the listed range.

The second heater line 275 may connect the heater 300 and the second valve 250 to each other. Compressed gas heated by the heater 300 may be discharged to the outside of the heater 300 through the second heater line 275.

The second valve 250 may be connected to the second line 231, the fourth line 233, the fifth line 270, and the second heater line 275. The second valve 250 may set a path of compressed gas, which passes through the second line 231, the fourth line 233, the fifth line 270, and the second heater line 275. For example, the second valve 250 may set a path of compressed gas so that the compressed gas having passed through the second heater line 275 is provided to the second line 231. The second valve 250 may set a path of compressed gas so that the compressed gas having passed through the second line 231 is provided to the fifth line 270.

According to embodiments, compressed gas having passed through the second heater line 275 may be provided to the second line 231 or the fourth line 233 by/via the second valve 250. For example, high-temperature compressed gas having passed through the second heater line 275 may be alternately provided to the second line 231 and the fourth line 233 by/via the second valve 250. In this case, when a compressed gas drying process is performed in the first tank 201, e.g., while compressed gas supplied to the first tank 201 through the first line 111 is supplied to the fifth line 270 by/via the second valve 250 through the second line 231 by passing through the first tank 201, compressed gas having passed through the second heater line 275 may be supplied to the fourth line 233 by/via the second valve 250.

On the contrary, when a compressed gas drying process is performed in the second tank 203, e.g., while compressed gas supplied to the second tank 203 through the third line 113 is supplied to the fifth line 270 by/via the second valve 250 through the fourth line 233 by passing through the second tank 203, compressed gas having passed through the second heater line 275 may be supplied to the second line 231 by/via the second valve 250.

According to embodiments, high-temperature compressed gas supplied to the second line 231 or the fourth line 233 through the second heater line 275 may be provided to the tank 200 to dry the adsorbent 210 filled in the tank 200. For example, high-temperature compressed gas supplied to the fourth line 233 through the second heater line 275 may be provided to the second tank 203, and the high-temperature compressed gas may dry the adsorbent 210 filled in the second tank 203 while passing through the second tank 203. The high-temperature compressed gas having passed through the second tank 203 may pass through the third line 113 and then be provided to the discharge line 170 by/via the first valve 150.

The dew point measuring instrument 500 may be configured to measure a dew point of compressed gas having passed through the discharge line 170. According to embodiments, the dew point measuring instrument 500 may include or may be a capacitive dew point meter or a mirror cooling dew point meter but is not limited thereto.

Compressed gas flowing in the discharge line 170 may have been introduced to the discharge line 170 through the second heater line 275, the second valve 250, the fourth line 233, the second tank 203, the third line 113, and the first valve 150 or through the second heater line 275, the second valve 250, the second line 231, the first tank 201, the first line 111, and the first valve 150. Therefore, the compressed gas having passed through the discharge line 170 may be high-temperature compressed gas supplied from the heater 300. For example, the high-temperature compressed gas having passed through the discharge line 170 may be high-temperature compressed gas having passed through the first tank 201 or the second tank 203.

The cooler 400 may be configured to cool the high-temperature compressed gas having passed through the discharge line 170. According to embodiments, the cooler 400 may cool compressed gas having passed through the discharge line 170 down to a temperature range of gas, which is measurable by the dew point measuring instrument 500. For example, the dew point measuring instrument 500 may have a measuring temperature range of a gas, and the cooler 400 may be used to adjust the temperature of the compressed gas for the dew point measuring instrument 500 to measure the dew point of the compressed gas. The cooler 400 may cool compressed gas having passed through the discharge line 170 before the compressed gas is provided to the dew point measuring instrument 500. For example, the compressed gas having passed through the discharge line 170 may first pass through the cooler 400 and then be provided to the dew point measuring instrument 500.

Therefore, even when a temperature of compressed gas having passed through the discharge line 170 exceeds the measurable temperature range of the dew point measuring instrument 500, the cooler 400 may allow the dew point measuring instrument 500 to measure a dew point of the compressed gas having passed through the discharge line 170.

The discharge line 170 may be connected to the first branched discharge line 171 and the second branched discharge line 173. A part of compressed gas having passed through the discharge line 170 may be provided to the first branched discharge line 171, and the other part of the compressed gas may be provided to the second branched discharge line 173. In this case, percentages of compressed gas branched to the first branched discharge line 171 and the second branched discharge line 173 may be adjusted by a third valve 190. The first branched discharge line 171 may be configured to discharge a part of compressed gas having passed through the discharge line 170 to the outside.

According to embodiments, the cooler 400 and the dew point measuring instrument 500 may be connected to the second branched discharge line 173. For example, the cooler 400 may cool compressed gas having passed through the second branched discharge line 173, and the dew point measuring instrument 500 may measure a dew point of the compressed gas having passed through the second branched discharge line 173.

The controller 600 may be configured to control an operation of the heater 300. For example, the controller 600 may be configured to control the heater 300 to start and stop. According to embodiments, the controller 600 may control the heater 300 to stop when a dew point of compressed gas having passed through the discharge line 170, which is provided by the dew point measuring instrument 500, is less than or equal to a first temperature. Herein, the first temperature may be a dew point of compressed gas having passed through the discharge line 170 after regeneration of the adsorbent 210, e.g., drying of the adsorbent 210, was finished. For example, each regeneration of adsorbent 210 described in the present disclosure may be a process of drying the adsorbent 210 for the adsorbent 210 to be restored to a pervious state in which the adsorbent 210 is in a condition to be used to dry a compressed gas in a tank 200.

A dew point of a gas is proportional to an amount of moisture included in the gas, and thus, the lower dew point of gas, the less an amount of moisture included in the gas. Therefore, the controller 600 may control the heater 300 to stop an operation thereof when an amount of moisture included in compressed gas having passed through the discharge line 170 is less than or equal to a certain amount.

For example, a regeneration finish time point of the adsorbent 210 may be determined using the dew point measuring instrument 500 configured to measure a dew point of compressed gas having passed through the discharge line 170, and when regeneration of the adsorbent 210 is finished, the heater 300 may be stopped using/by the controller 600.

Compressed gas provided to the tank 200 by passing through the second heater line 275, e.g., compressed gas flowing in the tank 200 to dry the adsorbent 210 in the tank 200, may have humidity varying depending on an ambient environment, e.g., depending on a season. In this case, whether to drive/operate the heater 300 simply depends on a timer, the heater 300 may be unnecessarily continuously driven even after the adsorbent 210 is completely dried when the heater 300 is not properly controlled.

However, the air dryer 10 according to a technical idea of the inventive concept may detect a regeneration finish time point of the adsorbent 210 by using the controller 600 and the dew point measuring instrument 500 configured to measure a dew point of compressed gas used to dry the adsorbent 210, and stop the heater 300 at the regeneration finish time point of the adsorbent 210. Accordingly, unnecessary driving of the heater 300 may be prevented, thereby saving power required for the equipment and reducing power consumption by the air dryer 10.

The controller 600 may be implemented by hardware, firmware, software, or any combination thereof. For example, the controller 600 may include or may be a computing device, such as a workstation computer, a desktop computer, a laptop computer, or a tablet computer. The controller 600 may include or may be a simple controller, a microprocessor, a complex processor, such as a central processing unit (CPU) or a graphics processing unit (GPU), a processor formed with software, or exclusive hardware or firmware. The controller 600 may be implemented by, for example, a general-purpose computer or application-specific hardware, such as a digital signal processor (DSP), a field programmable gate array (FPGA), or an application specific integrated circuit (ASIC). The controller 600 may be implemented by instructions stored in a machine-readable medium, which are readable and executable by one or more processors. Herein, the machine-readable medium may include or may be an arbitrary mechanism configured to store and/or transmit information in a form readable by a machine (e.g., a computing device). For example, the machine-readable medium may include or may be read-only memory (ROM), random access memory (RAM), a magnetic disk storage medium, an optical storage medium, flash memory devices, an electrical, optical, acoustic, or another form of radio/electromagnetic signal (e.g., a carrier, an infrared signal, a digital signal, or the like), or other arbitrary signal.

Referring to FIGS. 1B and 2, the air dryer 10-1 may include the tank 200, the first line 111, the third line 113, the second line 231, the fourth line 233, the fifth line 270, the heater 300, a first heater line 278, the second heater line 275, the first valve 150, the second valve 250, the discharge line 170, the first branched discharge line 171, the second branched discharge line 173, the cooler 400, the dew point measuring instrument 500, the controller 600, and a blower 900.

Hereinafter, descriptions of elements of the air dryer 10 made with reference to FIGS. 1A and 2 may be applied to the same elements of the air drier 10-1 and additional description will be omitted, and differences from the air dryer 10 are mainly described.

The air dryer 10-1 may further include the blower 900 in addition to the air dryer 10 of FIG. 1A. The blower 900 may be configured to supply external gas to the first heater line 278. Therefore, the air dryer 10-1 may supply gas to the heater 300 through the blower 900. According to embodiments, gas provided from the blower 900 may be supplied to the heater 300 through the first heater line 278.

As a result, the air dryer 10-1 may perform a drying process of the adsorbent 210 by using external gas having passed through the heater 300. For example, compressed gas provided from the compressor 100 may not be provided to the heater 300.

The compressed gas provided from the compressor 100 may be alternately supplied to the first line 111 and the third line 113. The compressed gas provided to the first line 111 may be entirely provided to the fab 800 through the first tank 201, the second line 231, the second valve 250, and the fifth line 270. The compressed gas provided to the third line 113 may be entirely provided to the fab 800 through the second tank 203, the fourth line 233, the second valve 250, and the fifth line 270. The fifth line 270 may be connected to the second valve 250 and configured to supply compressed gas provided from the second line 231 or the fourth line 233 to the fab 800.

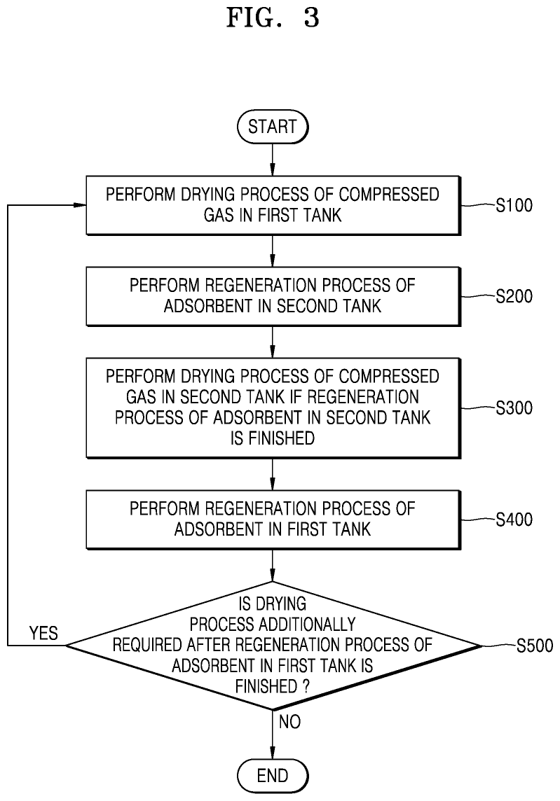

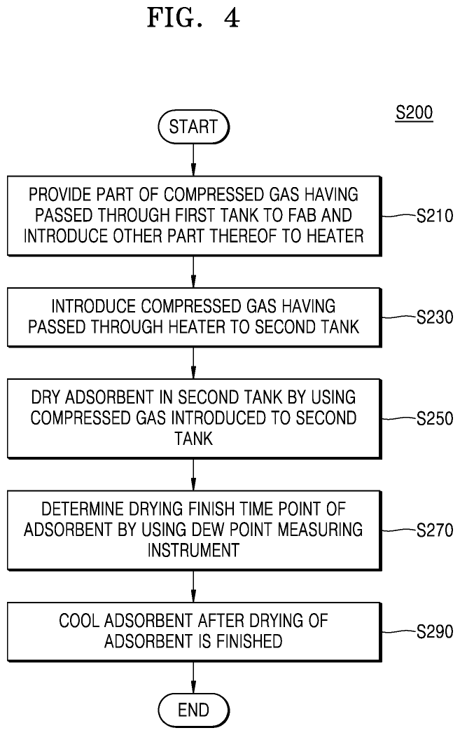

According to embodiments, gas provided from the blower 900 may be provided to the second valve 250 through the first heater line 278, the heater 300, and the second heater line 275. In this case, the second valve 250 may supply the gas to the second line 231 or the fourth line 233. The gas supplied to the second line 231 may dry the adsorbent 210 in the first tank 201, and the gas supplied to the fourth line 233 may dry the adsorbent 210 in the second tank 203. FIG. 3 is a flowchart illustrating a gas drying method of the air dryers 10 and 10-1 of FIGS. 1A and 1B. FIG. 4 is a flowchart illustrating an adsorbent regeneration method of an air dryer, according to a technical idea of the inventive concept. Hereinafter, a gas drying method using an air dryer, according to embodiments, is described in detail with reference to FIGS. 1A to 4. Descriptions of elements the same as the ones of FIGS. 1A to 2 will be omitted herein.

Referring to FIGS. 1A, 1B, 2, and 3, a drying process of compressed gas in the first tank is performed in operation S100.

In operation S100, compressed gas compressed by the compressor 100 is supplied to the first tank 201 through the gas supply line 110. Herein, the compressed gas having passed through the gas supply line 110 may be introduced to the first tank 201 through the first valve 150 and the first line 111.

The compressed gas introduced to the first tank 201 through the first line 111 may be dried by the adsorbent 210 filled in the first tank 201. For example, the adsorbent 210 may remove moisture of the compressed gas passing through the first tank 201. The moisture-removed compressed gas may be discharged to the outside of the first tank 201 through the second line 231. The compressed gas may be introduced to the fifth line 270 through the second line 231. Herein, the dried compressed gas having passed through the second line 231 may be introduced to the fifth line 270 through the second valve 250. A part of the dried compressed gas introduced to the fifth line 270 may be supplied to the fab 800 through the fabline 271.

Referring to FIGS. 1A to 4, while a drying process of compressed gas is performed in the first tank 201, a regeneration process (e.g., a drying process) of the adsorbent 210 is performed in the second tank 203 in operation S200.

According to embodiments, operation S200 in the air dryer 10 of FIG. 1A may include operation S210 of introducing, to the heater 300, a part of the compressed gas having passed through the first tank 201, operation S230 of introducing, to the second tank 203, the compressed gas having passed through the heater 300, operation S250 of drying the adsorbent 210 in the second tank 203 by using the compressed gas introduced to the second tank 203, operation S270 of determining a drying finish time point of the adsorbent 210 by using the dew point measuring instrument 500, and operation S290 of cooling the adsorbent 210 after drying of the adsorbent 210 is finished.

Referring to FIGS. 1A to 4, in operation S210, compressed gas dried by passing through the first tank 201 may be introduced to the fifth line 270, then, a part of the compressed gas may be provided to the fab 800 through the fabline 271, and the other part thereof may be provided to the heater 300 through the first heater line 273. In this case, percentages of the compressed gas introduced to the fabline 271 and the first heater line 273 are the same as described above with reference to FIGS. 1A and 2.

However, referring to FIGS. 1B and 3, in operation S200, a regeneration process of the adsorbent 210 in the second tank 203 of the air dryer 10-1 may include supplying gas provided from the blower 900 to the heater 300 through the first heater line 278, introducing the gas heated by the heater 300 to the second tank 203 through the fourth line 233, and drying the adsorbent 210 in the second tank 203. For example, unlike the air dryer 10 of FIG. 1A, external gas provided by the blower 900 is introduced to the heater 300.

The compressed gas (or external gas) introduced to the heater 300 through the first heater line 273 or 278 may be heated to a certain temperature. According to embodiments, the heater 300 may be a shell & tube type heat exchanger but is not limited thereto.

Referring to FIGS. 1A, 1B, and 4, in operation S230, the gas heated by the heater 300 may be discharged to the outside of the heater 300 through the second heater line 275 and introduced to the second tank 203 through the fourth line 233. For example, the gas heated by the heater 300 may be introduced to the second tank 203 by passing through the second heater line 275 and the fourth line 233. Herein, the gas having passed through the second heater line 275 may be introduced to the fourth line 233 through the second valve 250.

Referring to FIGS. 1A. 1B, 2, and 4, in operation S250, the gas introduced to the second tank 203 through the fourth line 233 may dry the adsorbent 210 in the second tank 203. Herein, the adsorbent 210 in the second tank 203 may be an adsorbent to be regenerated after a drying process of gas ends. For example, moisture may be removed from the adsorbent 210 after finishing moisture adsorption/absorption process adsorbing/absorbing moisture from the gas.

The gas introduced to the second tank 203 through the fourth line 233 may be high-temperature gas heated by the heater 300. The high-temperature gas may dry the adsorbent 210 in the second tank 203, thereby removing moisture from the adsorbent 210. For example, the high-temperature gas may dry the adsorbent 210 so that the adsorbent 210 returns to a state of being capable of removing moisture from gas, e.g., in a subsequent process.

The gas used to dry the adsorbent 210 may be discharged to the outside of the second tank 203 through the third line 113. The gas having passed through the third line 113 may be provided to the discharge line 170. In this case, the gas having passed through the third line 113 may be provided to the discharge line 170 by/via the first valve 150.

In operation S270, a regeneration finish time point of the adsorbent 210, e.g., a drying finish time point of the adsorbent 210, may be determined by the dew point measuring instrument 500. Herein, the gas, of which a dew point is measured by the dew point measuring instrument 500, may be gas provided to the discharge line 170 through the third line 113 after drying the adsorbent 210 in the second tank 203.

The gas having passed through the discharge line 170 may pass through the cooler 400 before provided to the dew point measuring instrument 500. The gas may be provided to the cooler 400 in advance to adjust a temperature of the gas to be within a measurable gas temperature range of the dew point measuring instrument 500.

A time point when a dew point of the gas measured by the dew point measuring instrument 500 is less than or equal to a certain temperature may be a time point when drying of the adsorbent 210 is finished. The certain temperature, e.g., a dew point temperature of the gas having passed through the discharge line 170 at the time point when drying of the adsorbent 210 is finished, may be the first temperature. As a result, when the dew point temperature of the gas having passed through the discharge line 170 is less than or equal to the first temperature, it may be determined that drying of the adsorbent 210 in the second tank 203 is finished.

According to embodiments, the dew point measuring instrument 500 may be provided to the second branched discharge line 173. In this case, a part of the gas having passed through the discharge line 170 may be discharged to the outside through the first branched discharge line 171, and the other part thereof may be provided to the dew point measuring instrument 500 through the second branched discharge line 173.

In operation S290, after drying of the adsorbent 210 in the second tank 203 is finished, the adsorbent 210 in the second tank 203 may be cooled. The adsorbent 210 heated by the drying may be cooled to a certain temperature or less so as to be used for a drying process of compressed gas, e.g., in a subsequent process.

According to embodiments, in operation S290, room-temperature gas may be provided to the second tank 203 to cool the adsorbent 210. When the cooling of the adsorbent 210 is finished, a regeneration process of the adsorbent 210 is finished.

Referring to FIGS. 1A, 1B, 2, and 3, after a regeneration process of the adsorbent 210 in the second tank 203 is finished, a drying process of the compressed gas may be performed in the second tank 203 in operation S300.

In operation S300, the compressed gas may be introduced to the second tank 203 through the gas supply line 110 and the third line 113.

The drying process of the second tank 203 in operation S300 is similar to or the same as the drying process of the first tank 201 described in operation S100. Moisture of the compressed gas introduced to the second tank 203 through the third line 113 may be removed by the adsorbent 210, of which regeneration has been finished, while the compressed gas passes through the second tank 203.

The compressed gas, of which the moisture has been removed while passing through the second tank 203, may be discharged to the outside of the second tank 203 through the fourth line 233. The compressed gas having passed through the second tank 203 may be provided to the fifth line 270 by passing through the fourth line 233. Herein, the compressed gas having passed through the fourth line 233 may be provided to the fifth line 270 by/via the second valve 250.

In the air dryer 10 of FIG. 1A, a part of the compressed gas provided to the fifth line 270 may be supplied to the fab 800 through the fabline 271, and the other part thereof may be supplied to the heater 300 by passing through the first heater line 273.

In the air dryer 10-1 of FIG. 1B, the compressed gas provided to the fifth line 270 may be supplied to the fab 800.

Referring to FIGS. 1A, 1B, 2, and 3, while a drying process of the compressed gas in the second tank 203 is performed, a regeneration process of the adsorbent 210 in the first tank 201 may be performed in operation S400.

In the air dryer 10 of FIG. 1A, a part of the compressed gas dried by passing through the second tank 203 may be supplied to the fabline 271, and the other part thereof may be supplied to the first heater line 273. The compressed gas supplied to the first heater line 273 may be provided to the heater 300 through the first heater line 273.

However, in the air dryer 10-1 of FIG. 1B, while a drying process of the compressed gas is performed in the second tank 203, gas supplied from the blower 900 may be provided to the heater 300 through the first heater line 278.

The gas provided to the heater 300 may be heated and provided to the second heater line 275, and the heated gas having passed through the second heater line 275 may be introduced to the first tank 201 through the second line 231. Herein, the heated gas having passed through the second heater line 275 may be provided to the second line 231 by/via the second valve 250.

The heated gas introduced to the first tank 201 may dry the adsorbent 210 in the first tank 201. The gas used to dry the adsorbent 210 in the first tank 201 may be discharged to the outside of the first tank 201 through the first line 111. The gas used to dry the adsorbent 210 in the first tank 201 may be provided to the discharge line 170 through the first line 111. In this case, the gas having passed through the first line 111 may be provided to the discharge line 170 by/via the first valve 150. In this case, the dew point measuring instrument 500 may measure a dew point temperature of the gas having passed through the discharge line 170 so that a drying finish time point of the adsorbent 210 in the first tank 201 is determined. According to embodiments, the dew point measuring instrument 500 may be provided to the second branched discharge line 173. The gas having passed through the discharge line 170 may be provided to the dew point measuring instrument 500 after cooled by the cooler 400 before passing through the dew point measuring instrument 500.

When a regeneration process of the first tank 201 is finished in operation S400, it is determined in operation S500 whether a drying process of the compressed gas is additionally required. Herein, when an additional drying process of the compressed gas is required, the gas drying method proceeds back to operation S100 to perform a drying process of the compressed gas in the first tank 201 and perform a regeneration process of the adsorbent 210 in the second tank 203. Otherwise, when an additional drying process of the compressed gas is not required, the gas drying method ends.

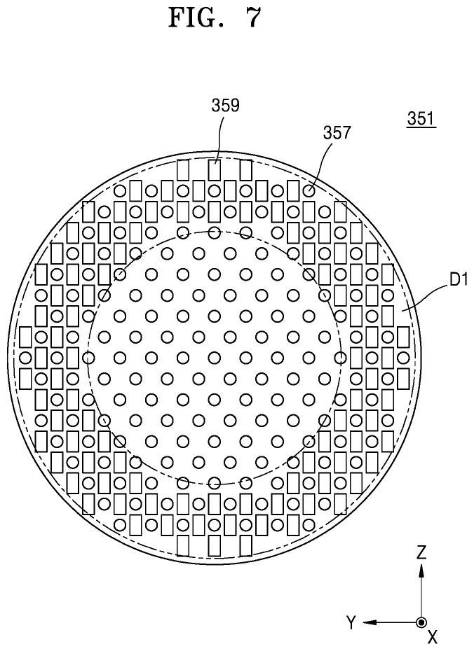

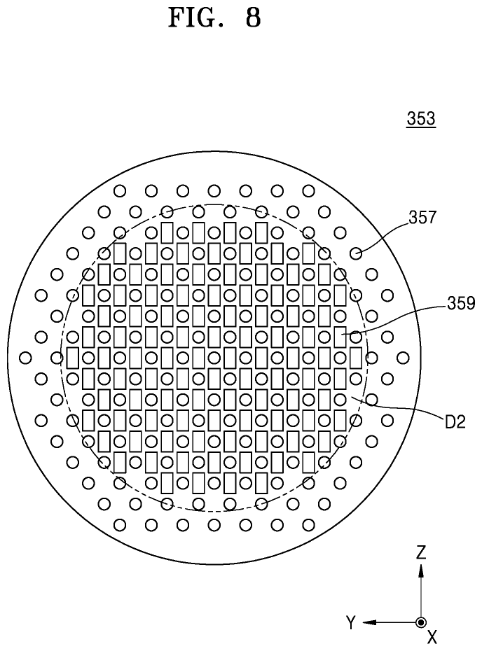

FIG. 5 is a schematic conceptual diagram illustrating the heater 300 of an air dryer, according to a technical idea of the inventive concept. FIG. 6 is a schematic conceptual diagram illustrating a flow of gas passing through the inside of the heater 300 of FIG. 5. FIGS. 7 and 8 are schematic cross-sectional views illustrating a first baffle 351 and a second baffle 353 in the heater 300 of FIG. 5.

Referring to FIGS. 5 to 8, the heater 300 may include a housing 310, a baffle 350, a hot wire 330, an inlet 371, and an outlet 373.

The housing 310 may have a shape having a space formed therein, and extending in a first direction. According to embodiments, the housing 310 may have a cylindrical shape extending in the first direction. The first direction may be the first horizontal direction X as shown in FIG. 5 but is not limited thereto, and the first direction may be the second horizontal direction Y or the vertical direction Z.

The baffle 350 may be provided in the housing 310 and arranged to be substantially parallel to a first plane of which a normal vector is the first direction. For example, the baffle 350 may be inside the housing 310 to be parallel to a plane that is perpendicular to a direction in which the housing 310 extends. For example, when the first direction that is the direction in which the housing 310 extends is the first horizontal direction X, the first plane may be a Y-Z plane having a normal vector in the first horizontal direction X, and the baffle 350 may be inside the housing 310 to be parallel to the Y-Z plane. For example, the extending direction of the cylindrical shape of the housing 310 may be parallel to an axis of rotational symmetry of the cylindrical shape.

Terms such as “same,” “equal,” “parallel,” “perpendicular,” “planar,” or “coplanar,” as used herein encompass identicality or near identicality including variations that may occur, for example, due to manufacturing processes. The term “substantially” may be used herein to emphasize this meaning, unless the context or other statements indicate otherwise.

A plurality of baffles 350 may be provided. The plurality of baffles 350 may be inside the housing 310 to be separated (e.g., spaced apart) from each other in the first direction. According to embodiments, a first baffle 351 and a second baffle 353 may be provided in the housing 310.

According to embodiments, a cross-sectional area of the baffle 350 on the first plane may be the same or substantially the same as a cross-sectional area of inside of the housing 310 on the first plane. The cross-sectional area of inside of the housing 310 may indicate an area of a vacant space in a cross-section of the housing 310 on the first plane. For example, the baffle 350 may be fit and fixed to the housing. For example, the baffle 350 may be fixed inside the housing 310 by a normal force between the baffle 350 and the housing 310.

The baffle 350 may include a second hole 357 extending in the first direction. The second hole 357 may be formed in both the first baffle 351 and the second baffle 353. For example, a position and shape of the second hole 357 formed in the first baffle 351 may be substantially the same as a position and shape of the second hole 357 formed in the second baffle 353. According to embodiments, a plurality of second holes 357 may be provided, and the plurality of second holes 357 may be separated (e.g., spaced apart) from each other. The plurality of second holes 357 may be uniformly/regularly formed all over the surface of the baffle 350. For example, the second holes 357 may pass through the baffle 350 in the first direction. For example, each of the plurality of the second holes 357 formed in the first baffle 351 may overlap a corresponding one of the plurality of the second holes 357 formed in the second baffle 353 in the first direction.

According to embodiments, the hot wire 330 may be inserted into the second hole 357. When the plurality of second holes 357 are provided, a plurality of hot wires 330 may be inserted into the plurality of second holes 357, respectively. The hot wire 330 may be inserted into the second hole 357 and fixed inside the housing 310. In this case, the hot wire 330 may extend in the first direction inside the housing 310. The plurality of second holes 357 may be uniformly/regularly formed in the baffle 350. The hot wire 330 may raise a temperature of gas introduced to the inside of the housing 310.

According to embodiments, the second hole 357 may have a circular shape. For example, the second hole 357 may be a hole passing through the baffle 350 in the first direction and having a cylindrical shape. A cross-sectional area of the second hole 357 on the first plane may be substantially the same as a cross-sectional area of the hot wire 330 on the first plane. For example, when the first direction in which the housing 310 extends is the first horizontal direction X, a cross-sectional area of the second hole 357 on the Y-Z plane may be substantially the same as a cross-sectional area of the hot wire 330 on the Y-Z plane. For example, a footprint of the second hole 357 on the Y-Z plane may be the same or substantially the same as a footprint of the hot wire 330 on the Y-Z plane. Accordingly, when the hot wire 330 is inserted into the second hole 357 of the baffle 350, no gap may be formed between the hot wire 330 and the second hole 357. Because no gap is formed between the hot wire 330 and the second hole 357, gas provided in the housing 310 may not pass through the second hole 357.

The first baffle 351 may include a first hole 359 extending in the first direction in a first region D1. The first hole 359 may be a path through which gas introduced through the inlet 371 passes. For example, the first hole 359 may provide a path through which the gas is movable in the first direction.

According to embodiments, a cross-section of the first hole 359 on the first plane may have a quadrangular shape but is not limited thereto. According to embodiments, a plurality of first holes 359 may be provided. The plurality of first holes 359 formed in the first baffle 351 may be separated by a certain distance from each other in the first region D1. The plurality of first holes 359 formed in the first baffle 351 may be separated (e.g., spaced apart) by the certain distance from each other and fill the first region D1. According to embodiments, the first hole 359 formed in the first baffle 351 may be between adjacent second holes 357 in the first region D1. According to embodiments, the first region D1 may be a perimeter part of a cross-section of the first baffle 351 on the first plane. For example, the first region D1 may be a part having a doughnut shape at the perimeter part of the cross-section of the first baffle 351 on the first plane. For example, the first holes 359 may be formed in the first baffle 351 farther than a half of a radius of the first baffle 351 from the center of the first baffle 351 on the first plane. For example, the first holes 359 may not be formed in the first baffle 351 within a half of the radius of the first baffle 351 from the center of the first baffle 351 on the first plane. For example, the first region D1 may be a periphery region of the first baffle 351 and a width of the first region D1 in a radial direction of the first baffle 351 may be less than a half of the radius of the first baffle 351. For example, the first region D1 of the first baffle 351 may be spaced apart from the center of the first baffle 351 on the first plane.

The second baffle 353 may include the first hole 359 extending in the first direction in a second region D2. According to embodiments, a plurality of first holes 359 may be provided. For example, the second baffle 353 may include the plurality of first holes 359 formed and separated (e.g., spaced apart) by a certain distance from each other in the second region D2. The plurality of first holes 359 in the second baffle 353 may be separated by the certain distance from each other and fill the second region D2. The plurality of second holes 357 formed in the second baffle 353 may be separated (e.g., spaced apart) by a certain distance from each other in the second region D2. According to embodiments, the second region D2 may be a center part of a cross-section of the second baffle 353 on the first plane. For example, the second region D2 may be a part having a circular shape at the center part of the cross-section of the second baffle 353 on the first plane. For example, the second baffle 353 and the second region D2 of the second baffle 353 may be concentric on the first plane. For example, the second region D2 of the second the baffle 353 may have a radius greater than a half of a radius of the second baffle 353 and lesser than 80% of the radius of the second baffle on the first plane. For example, the first holes 359 may be formed within 80% of a radius of the second baffle 353 from the center of the second baffle 353 on the first plane. For example, the first holes 359 may not be formed in the second baffle 353 farther than 80% of the radius of the second baffle 353 on the first plane.

Because the first baffle 351 has the plurality of first holes 359 formed in the first region D1, and the second baffle 353 has the plurality of first holes 359 formed in the second region D2, when gas introduced to the inside of the housing 310 passes through different types of the baffles 350, the gas flow may have a cross-flow. For example, when gas having passed through the first baffle 351 passes through the second baffle 353, the gas may flow in a form of converging from the perimeter part to the center part, e.g., in a cross-sectional view. When gas having passed through the second baffle 353 passes through the first baffle 351, the gas may flow in a form of diverging from the center part to the perimeter part, e.g., in a cross-sectional view. This turbulent flow may increase a thermal conduction coefficient, thereby increasing heat transfer from the hot wires 330 to the gas and more efficiently raising a temperature of gas passing through the housing 310. For example, a temperature difference between gas introduced to the housing 310 and gas discharged from the housing 310 may increase. Because the time taken for gas to pass through the housing 310 is also increased due to the turbulent flow of the gas provided to the housing 310, a heat transfer time taken for the hot wire 330 to transfer heat to the gas may increase. Therefore, a temperature rise of gas passing through the housing 310 may increase.

The flow of the gas in a form of converging from the perimeter part to the center part or the flow of the gas in a form of diverging from the center part to the perimeter part may decrease a resistance between the baffle 350 and the gas, thereby decreasing pressure inside the heater 300. Accordingly, vibration occurring in the heater 300 due to a gas flow may be decreased/prevented.

The first baffle 351 and the second baffle 353 may be alternately arranged inside the housing 310 in the first direction. For example, the second baffle 353 may be provided between adjacent first baffles 351, and/or the first baffle 351 may be provided between adjacent second baffles 353.

By alternately arranging the first baffle 351 and the second baffle 353, a flow as shown in FIG. 6 may appear. A flow moving from the perimeter to the center and from the center back to the perimeter may be repeated.

According to embodiments, when the plurality of baffles 350 are provided, the first baffles 351 may be arranged adjacently in odd numbers from the inlet 371, and the second baffle 353 may be arranged adjacently in even numbers from the inlet 371. In certain embodiments, the first baffles may be even numbers and the second baffle(s) may be odd number(s) as shown in FIG. 6. For example, the first baffle 351 may be arranged to be most adjacent to the inlet 371, the second baffle 353 may be arranged to be separated from the first baffle 351 in the first direction, and the first baffle 351 may be arranged to be separated by a certain distance from the second baffle 353 in the first direction. In certain embodiments, the number of the first baffles and the number of the second baffles may be the same and the numbers of the first baffles and the second baffles may be even numbers or odd numbers.

According to embodiments, an opening ratio of the first hole 359 in the first baffle 351 may differ from an opening ratio of the first hole 359 in the second baffle 353. The opening ratio may be a ratio of an area of openings of the first holes 359 to a cross-sectional area of the baffle 350 on the first plane. For example, the opening ratio may be expressed as a percentage of the openings with respect to the area of the baffle 350.

According to embodiments, the opening ratio of the first hole 359 in the first baffle 351 may be within a range of about 30% to about 40%, and the opening ratio of the first hole 359 in the second baffle 353 may be within a range of about 40% to about 50%. When the opening ratio of the first hole 359 in the first baffle 351 and the opening ratio of the first hole 359 in the second baffle 353 are within the ranges described above, a temperature raise effect of gas passing through the heater 300 may increase.

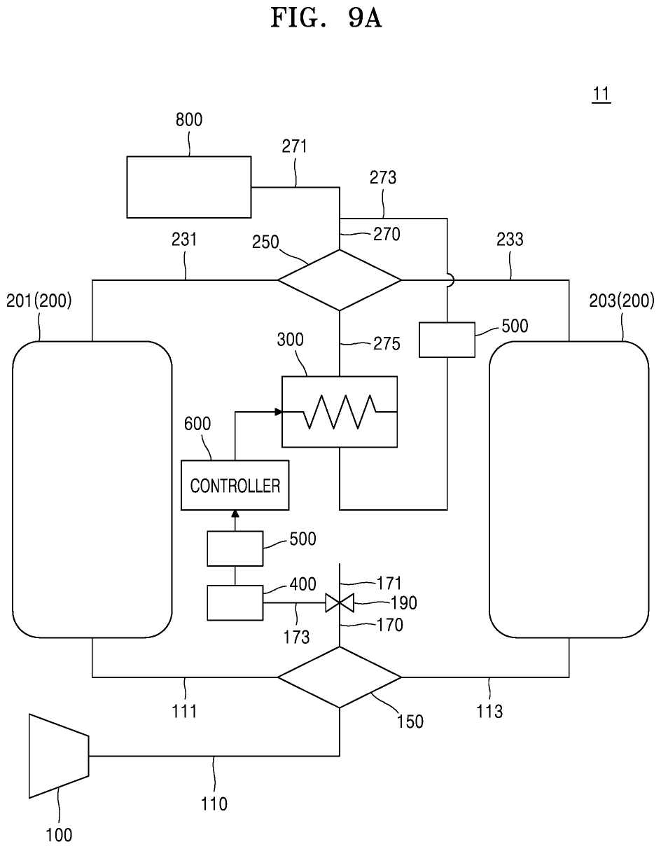

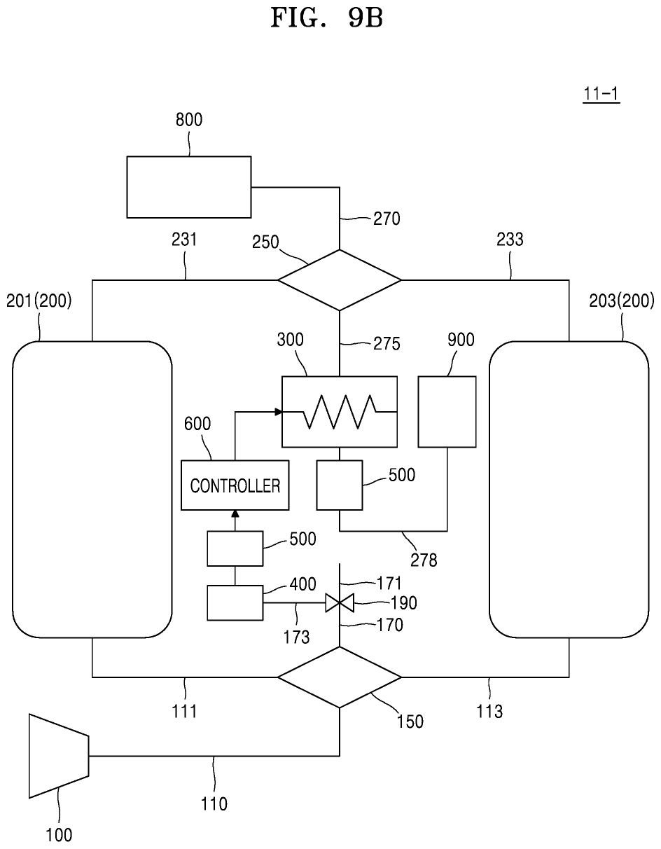

FIG. 9A is a schematic structural diagram illustrating an air dryer 11 according to a technical idea of the inventive concept. Hereinafter, descriptions of elements the same as the ones described with respect to the air dryer 10 of FIG. 1A are not repeated in a description of the air dryer 11 of FIG. 9A, and differences between the air dryers 10 and 11 are mainly described.

Referring to FIG. 9A, the air dryer 11 may further include the dew point measuring instrument 500 provided to the first heater line 273. The dew point measuring instrument 500 provided to the first heater line 273 may measure a dew point of gas before introduced to the tank 200 for a regeneration process. For example, gas supplied to the first heater line 273 may pass through the heater 300 and the second heater line 275 and then be supplied to the tank 200 for adsorbent regeneration. In this case, because the gas having passed through the first heater line 273 does not have a large change in a dew point before supplied to the tank 200, a dew point temperature of the gas having passed through the first heater line 273 may be the same, substantially the same as or similar to a dew point temperature of the gas immediately before introduced to the tank 200 for adsorbent regeneration.

Because the air dryer 11 further includes the dew point measuring instrument 500 provided to the first heater line 273, a dew point temperature difference of the gas between before and after introduced to the tank 200 for adsorbent regeneration may be measured. Because the dew point temperature difference indicates a difference in moisture included in the gas, when a difference between a dew point temperature of the gas before introduced to the tank 200 and a dew point temperature of the gas having passed through the tank 200 is less than or equal to a certain temperature, it may be determined that regeneration of an adsorbent in the tank 200 is finished. A second temperature may be understood as the dew point temperature difference at a time point when adsorbent regeneration is finished.

The air dryer 11 may further include the controller 600. The controller 600 may control the heater 300 to stop when a difference between a dew point temperature of gas having passed through the first heater line 273 and a dew point temperature of gas having passed through the discharge line 170 is less than or equal to the second temperature.

As a result, the air dryer 11 may accurately determine a regeneration process finish time point of the adsorbent by using the dew point measuring instrument 500 provided to the first heater line 273 and accordingly stop driving the heater 300, thereby saving power consumption required for the equipment.

FIG. 9B is a schematic structural diagram illustrating an air dryer 11-1 according to a technical idea of the inventive concept. Hereinafter, descriptions of elements the same as the ones described with respect to the air dryer 10-1 of FIG. 1B are not repeated in a description of the air dryer 11-1 of FIG. 9B, and differences between the air dryers 10-1 and 11-1 are mainly described.

Referring to FIG. 9B, the air dryer 11-1 may further include the dew point measuring instrument 500 provided to the first heater line 278. The dew point measuring instrument 500 provided to the first heater line 278 may measure a dew point of gas before introduced to the tank 200 for a regeneration process. For example, gas supplied to the first heater line 278 by the blower 900 may pass through the heater 300 and the second heater line 275 and then be supplied to the tank 200 for adsorbent regeneration. In this case, because the gas having passed through the first heater line 278 does not have a large change in a dew point before supplied to the tank 200, a dew point temperature of the gas passing through the first heater line 273 may be substantially the same as or similar to a dew point temperature of the gas immediately before introduced to the tank 200 for adsorbent regeneration.

Because the air dryer 11-1 further includes the dew point measuring instrument 500 provided to the first heater line 278, a dew point difference of the gas between before and after introduced to the tank 200 for adsorbent regeneration may be measured. Because the dew point difference indicates a difference in moisture included in the gas, when a difference between a dew point temperature of the gas before introduced to the tank 200 and a dew point temperature of the gas having passed through the tank 200 is less than or equal to a certain temperature, it may be determined that regeneration of an adsorbent in the tank 200 is finished. The second temperature may be understood as the dew point temperature difference at a time point when adsorbent regeneration is finished.

Even though different figures illustrate variations of exemplary embodiments and different embodiments disclose different features from each other, these figures and embodiments are not necessarily intended to be mutually exclusive from each other. Rather, features depicted in different figures and/or described above in different embodiments can be combined with other features from other figures/embodiments to result in additional variations of embodiments, when taking the figures and related descriptions of embodiments as a whole into consideration. For example, components and/or features of different embodiments described above can be combined with components and/or features of other embodiments interchangeably or additionally to form additional embodiments unless the context indicates otherwise.

While the inventive concept has been particularly shown and described with reference to embodiments thereof, it will be understood that various changes in form and details may be made therein without departing from the spirit and scope of the following claims.

What is claimed is:

1. An air dryer comprising:
a first tank having a space formed therein;
a first line configured such that a gas is supplied to an inside of the first tank through the first line;
a heater configured to heat the gas; and
a first heater line configured such that the gas is supplied to the heater through the first heater line,
wherein the heater comprises:
a housing having a shape extending in a first direction and having a space formed therein;
a plurality of baffles arranged in the housing to be substantially parallel to a first plane of which a normal vector is parallel to the first direction, the plurality of baffles separated from each other in the first direction; and
a hot wire passing through each of the plurality of baffles in the first direction,
wherein the plurality of baffles comprise: a first baffle having a plurality of first holes formed in a first region to extend in the first direction; and a second baffle having a plurality of first holes formed in a second region other than the first region to extend in the first direction.

2. The air dryer of claim 1, wherein a cross-section of each of the plurality of baffles has a circular shape on the first plane, the first region is a part having a doughnut shape at a perimeter of a cross-section of the first baffle on the first plane, and the second region is a part having a circular shape at a center of a cross-section of the second baffle on the first plane.

3. The air dryer of claim 2, wherein an opening area of the plurality of first holes in the first baffle is within a range of about 30% to about 40% of the whole area of the first baffle on the first plane, and an opening area of the plurality of first holes in the second baffle is within a range of about 40% to about 50% of the whole area of the second baffle on the first plane.

4. The air dryer of claim 1, wherein the first baffle and the second baffle are alternately arranged in the first direction.

5. The air dryer of claim 4, wherein the heater comprises an inlet configured such that the gas is introduced through the inlet and an outlet configured such that the gas is discharged through the outlet, and among the plurality of baffles, the first baffle is sequentially arranged in odd numbers from the inlet, and the second baffle is sequentially arranged in even numbers from the inlet.

6. The air dryer of claim 1, wherein a cross-sectional area and shape of each of the plurality of baffles on the first plane are substantially the same as a cross-sectional area and shape of an inside of the housing on the first plane.

7. The air dryer of claim 1, wherein each of the plurality of baffles comprises a second hole extending in the first direction, the hot wire passes through the second hole, and a cross-sectional area of the second hole on the first plane is substantially the same as a cross-sectional area of the hot wire on the first plane.

8. The air dryer of claim 1, further comprising:
a second line connected to the first tank;
a second tank having a space formed therein;
a third line connected to the second tank;
a first valve connected to the third line and the first line;
a second valve connected to the second line;
a fourth line connecting the second valve and the second tank to each other;
a fifth line connected to the second valve;
a second heater line connecting the heater and the second valve to each other; and
a discharge line connected to the first valve.

9. The air dryer of claim 8, further comprising a dew point measuring instrument configured to measure a dew point of the gas having passed through the discharge line.

10. An air dryer comprising:
a first tank having a space formed therein;
a first line configured such that a gas is supplied to an inside of the first tank;
a heater configured to heat the gas;
a first heater line configured such that the gas is supplied to the heater through the first heater line;
a second tank having a space formed therein;
a fourth line configured such that the gas having passed through the heater is supplied to the second tank through the fourth line;
a discharge line configured such that the gas having passed through the second tank is discharged to the outside through the discharge line; and
a first dew point measuring instrument configured to measure a dew point of the gas having passed through the discharge line.

11. The air dryer of claim 10, further comprising a controller configured to control operation of the heater,
wherein the controller is further configured to control the heater to stop when a dew point temperature of the gas measured by the first dew point measuring instrument is less than or equal to a first temperature.

12. The air dryer of claim 10, further comprising a first branched discharge line and a second branched discharge line, which are branched from the discharge line,
wherein the first dew point measuring instrument is configured to measure a dew point of the gas having passed through the second branched discharge line.

13. The air dryer of claim 10, further comprising a cooler configured to cool the gas having passed through the discharge line,
wherein the first dew point measuring instrument is configured to measure a dew point of the gas having passed through the cooler.

14. The air dryer of claim 10, further comprising a second dew point measuring instrument configured to measure a dew point of the gas having passed through the first heater line.

15. The air dryer of claim 14, further comprising a controller configured to control operation of the heater,
wherein the controller is further configured to control the heater to stop when a difference between a dew point temperature of the gas having passed through the first heater line and a dew point temperature of the gas having passed through the discharge line is less than or equal to a second temperature.

16. The air dryer of claim 10, wherein the heater comprises:
a housing having a shape extending in a first direction and having a space formed therein;
a plurality of baffles provided in the housing, arranged substantially parallel to a first plane of which a normal vector is parallel to the first direction, and separated from each other in the first direction; and
a hot wire passing through each of the plurality of baffles, in the first direction,
wherein the plurality of baffles comprise: a first baffle having a plurality of first holes formed in a first region and extending in the first direction; and a second baffle having a plurality of first holes formed in a second region and extending in the first direction.

17. The air dryer of claim 10, further comprising:
a second line connected to the first tank;
a third line connected to the second tank;
a first valve connected to the third line and the first line;
a second valve connected to the second line;
a fifth line connected to the second valve; and
a second heater line connecting the heater and the second valve to each other,
wherein the discharge line is connected to the first valve, and the fourth line is connected to the second valve.

18. A compressed gas drying method comprising:
providing compressed gas compressed by a compressor to an air dryer;
drying the compressed gas in a first tank in which an adsorbent is provided;
in a second tank in which an adsorbent is provided, regenerating the adsorbent;
drying the compressed gas in the second tank after finishing the regeneration of the adsorbent in the second tank; and
regenerating, in the first tank, the adsorbent provided in the first tank,
wherein the regenerating of the adsorbent provided in the second tank comprises:
drying the adsorbent provided in the second tank; and
cooling the dried adsorbent,
wherein the drying of the adsorbent comprises:
providing gas to a heater;
providing, to the second tank, the gas having passed through the heater;
measuring a dew point temperature of the gas having passed through the second tank; and
stopping the heater when the dew point temperature is measured as being less than or equal to a first temperature.

19. The compressed gas drying method of claim 18, wherein the measuring of the dew point temperature of the gas having passed through the second tank comprises cooling the compressed gas having passed through the second tank.

20. The compressed gas drying method of claim 19, wherein the heater comprises:
a housing having a shape extending in a first direction and having a space formed therein;
a plurality of baffles arranged in the housing to be substantially parallel to a first plane of which a normal vector is parallel to the first direction, and separated from each other in the first direction; and
a hot wire passing through each of the plurality of baffles in the first direction,
wherein the plurality of baffles comprise:
a first baffle having a plurality of first holes formed in a first region that is a perimeter region and extending in the first direction; and
a second baffle having a plurality of first holes formed in a second region that is a center region and extending in the first direction.
